(19) United States
(12) Patent Application Publication
(10) Pub. No.: US 2006/0256403 A1
(43) Pub. Date: Nov. 16, 2006

(54) Optical scanning module of scanning apparatus

(76) Inventor: Chin-Yuan Lin, Taichung City (TW)

Correspondence Address: RABIN & Berdo, PC, 1101 14TH STREET, NW, SUITE 500, WASHINGTON, DC, 20005, US

(21) Appl. No.: 11/430,038

(22) Filed: May 9, 2006

(30) Foreign Application Priority Data
May 13, 2005 (TW) 94115685

(51) Int. Cl. H04N 1/393

(52) U.S. Cl. 358/484; 358/451

(57) ABSTRACT

An optical scanning module disposed in a scanning apparatus for acquiring an image of a document is disclosed. The optical scanning module comprises an light-sensing component, for sensing a light signal of the document and converting the light signal to an analog image signal; a front end processor, coupled to the light-sensing component for receiving and converting the I analog image signal to a digital image signal; and an application specific integrated circuit, for receiving and processing the digital image signal, and outputting an processed digital image signal.

This application claims the benefit of Taiwan application Serial No. 94115685, filed May 13, 2005, the subject matter of which is incorporated herein by reference.

### BACKGROUND OF THE INVENTION

1. Field of the Invention

The invention relates in general to a scanning apparatus, and more particularly to a scanning apparatus that integrates a light-sensing component, an analog front end processor and an application specific integrated circuit (ASIC) into the optical scanning module.

2. Description of the Related Art

Referring to FIG. 1, a block diagram illustrating a conventional scanner is shown. The conventional scanner includes an optical scanning module 110 and a main board 150 fixed on the body of the scanner. The optical scanning module 110 includes a charge couple device (CCD) module 115 for detecting a light signal. An application specific integrated circuit (ASIC) 151 and an analog front end (AFE) processor 153 are arranged and disposed on the main board 150, for controlling the charge couple device module 115, and receiving the light signal and converting the light signal to the digital form, respectively.

During scanning, the optical scanning module 110 of the scanner moves relatively with the to-be-scanned document, and the charge couple device module 115 simultaneously detects the light signal, which is reflected or transmitted from the to-be-scanned document. The light signal converts to the light analog signal RGB. After the charge couple device module 115 detects the light signal, the application specific integrated circuit 151 obtains the light analog signal RGB in accordance with the control signal (CTRL), and then proceeds the following procedures of image processing. Especially, the light analog signal RGB can not be processed digitally, so that the light analog signal RGB is converted to a digital form by the analog front end processor 153. Afterward, the light digital signal is transmitted through the BUS to the application specific integrated circuit 151 through the BUS for the following image processing.

Additionally, when the scanner is a flatbed scanner, the drive motor 155 is disposed on the scanner. The drive motor 155 controls the movement of the optical scanning module 110 according to the command, which is transmitted from the application specific integrated circuit 151, such as the specific start-stop movement of the scanner.

Also, a memory 157 is disposed on the main board 150. The memory 157 is a data buffer for storing scanning data temporarily.

In the practical operation, since the analog front end processor 153 and application specific integrated circuit 151 are both disposed on the main board 150, there are numerous connecting lines between the main board 150 and the optical scanning module 110. In addition to three light signal lines (each of which is for transmitting one of the three primary color (RGB) signals), the various signals, such as the φ1 and φ2 signals, the reset signal, the power signal, and the grounding signal (GND) of the CCD control signal (CTRL) are further included. Please referring to FIG. 2, a layout illustrating a charge couple device module (CCD) manufactured by Sony Inc. The CCD product of Sony, commercially named as ILX558K, requires twelve input/output pins and the numerous signal lines in the circuit connection, resulting in the high manufacture cost. Furthermore, the light analog signal RGB transmitted from the charge couple device module 115 to the main board 150 is easily to be suffered from the electromagnetic interference (EMI). The light analog signal RGB maybe produces distortion due to the electromagnetic interference. So, the quality of the scanned image will be reduced.

### SUMMARY OF THE INVENTION

It is therefore an object of the invention to provide a scanning apparatus. The scanning apparatus can reduce the number of the signal lines and shorten the length of the signal lines. Besides, the EMI caused by the signal lines are reduced significantly when the data is transmitted.

The invention achieves the above-identified object by providing an optical scanning module disposed in a scanning apparatus for acquiring an image of a document. The optical scanning module comprises a light-sensing component, a front end processor, and an application specific integrated circuit. The light-sensing component for sensing a light signal of the document and converting the light signal to an analog image signal; the front end processor, coupled to the light-sensing component for receiving the analog image signal and converting the analog image signal to a digital image signal; and an application specific integrated circuit, for receiving and processing the digital image signal, and outputting a processed digital image signal.

The invention also achieves the above-identified object by providing a scanning apparatus. The scanning apparatus is electrically connected to a controlling device, wherein the controlling device controls the scanning apparatus for proceeding the scanning procedures. The scanning apparatus comprises a main body, and an optical scanning module. The optical scanning module includes a light-sensing component, a front end processor, and an application specific integrated circuit. The optical scanning module is disposed in the main body for acquiring an image of a document. The light-sensing component is used for sensing a light signal of the document and converting the light signal to an analog image signal; the front end processor is coupled to the light-sensing component for receiving the analog image signal and converting the analog image signal to a digital image signal; and the application specific integrated circuit is used for receiving and processing the digital image signal, and transmitting an processed digital image signal to the controlling device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a block diagram illustrating a conventional scanner.

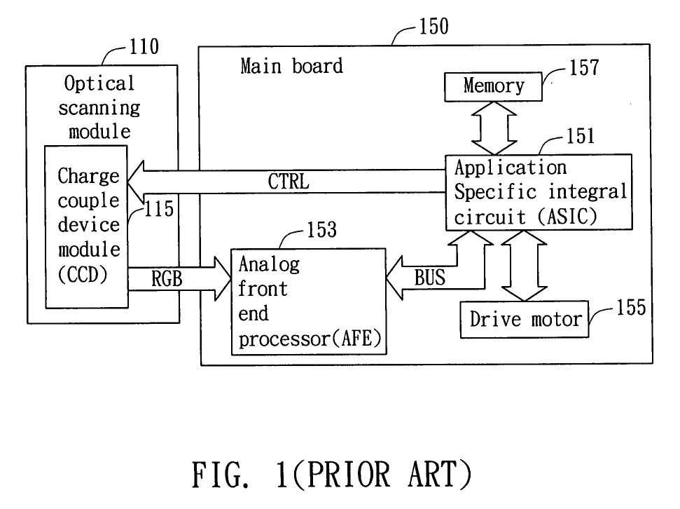

FIG. 2 (Prior Art) is a layout illustrating a charge couple device module (CCD) manufactured by Sony Inc.

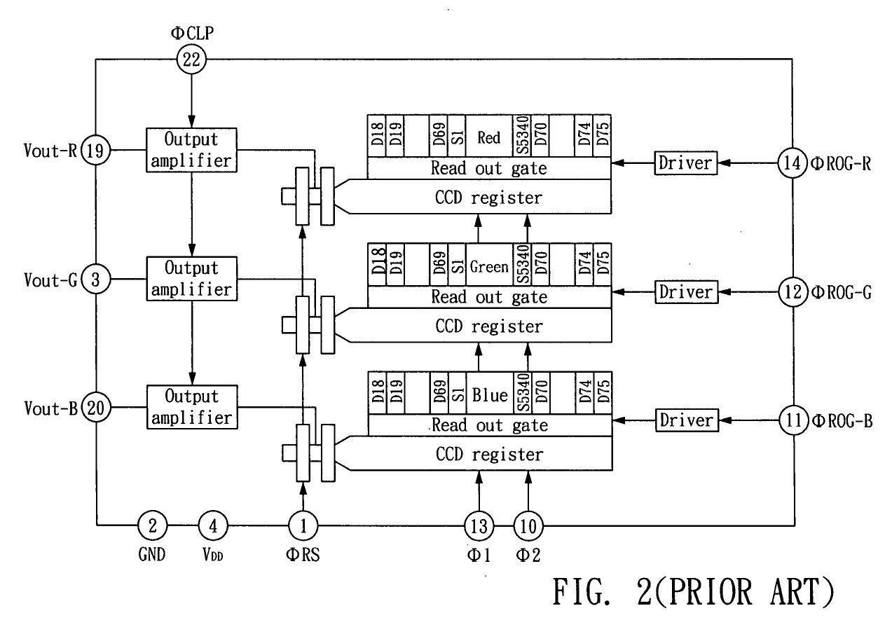

FIG. 3 schematically shows a scanning apparatus in the first embodiment of the present invention.

FIG. 4 is a block diagram showing the scanning apparatus of FIG. 3 disposed on a circuit board.

FIG. 5 schematically shows a scanning apparatus in the second embodiment of the present invention.

FIG. 6 schematically shows a scanning apparatus in the third embodiment of the present invention.

### DETAILED DESCRIPTION OF THE INVENTION

### First Embodiment

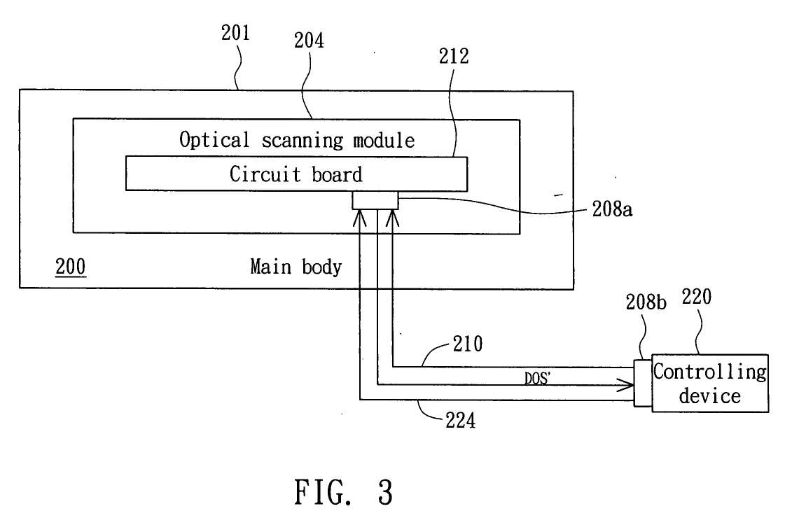

FIG. 3 schematically shows a scanning apparatus in the first embodiment of the present invention. The scanning apparatus 200 includes a main body 201 and an optical scanning module 204. The optical scanning module 204 is disposed in the main body 201. The optical scanning module 204 proceeds the scanning procedures under the control by the controlling device 220. The controlling device 220 could be a processor built in the scanning apparatus 200, or an external computer. A circuit board 212 disposed on the optical scanning module 204 is electrically connected to the controlling device 220 via the signal line 210.

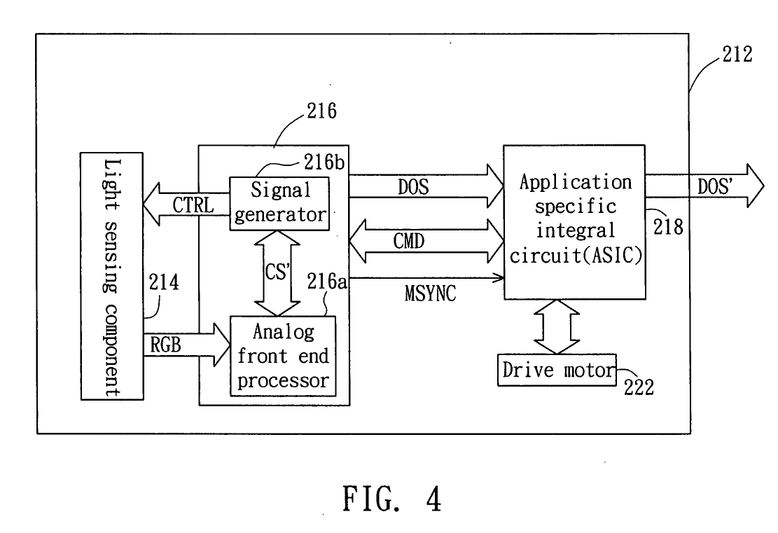

FIG. 4 is a block diagram showing the scanning apparatus of FIG. 3 disposed on a circuit board. A light-sensing component 214, a front end processor 216, an application specific integrated circuit (ASIC) 218 and a drive motor 222 are disposed on the circuit board 212. The light-sensing component 214 detects the light signal reflected from the document or transmitted the document, and then converts the light signal into an analog image signal RGB. Examples of the light-sensing component 214 include a charge couple device (CCD) or a complementary metal oxide semiconductor (CMOS). The front end processor 216 has an analog front end device 216a and a signal generator 216b. The analog front end device 216a is coupled to a light-sensing component 214 for converting the analog image signal RGB into the digital image signal DOS. The signal generator 216b is coupled to the light-sensing component 214 and the analog front end device 216a, for generating a control signal CTRL and an analog front end control signal CS′. The light-sensing component 214 outputs each pixel corresponding to the analog image signal RGB sequentially under the control of the control signal CTRL. The analog front end device 216a uses the analog front end control signal CS′ as the clock signal to convert the analog image signal RGB to the digital image signal DOS′.

Please refer to both FIG. 3 and FIG. 4. The application specific integrated circuit 218 is used to process the digital image signal DOS′ and to receive the image transmitting control signal (not shown in the figures) from the controlling device 220. The digital image signal DOS′ is then transmitted to the controlling device 220. The application specific integrated circuit 218 transmit command to the front end processor 216 via a command interface CMD, allowing the front end processor 216 for image capturing, signal conversion, and data feedback (for example, looking into the table according to the command or making the communication protocol between the front end processor 216 and application specific integrated circuit 218).

The drive motor 222 is also disposed in the scanning apparatus 200. The gears of the output end of the drive motor 222 (not shown in the figures), engaged with the belt (not shown) which is secured on the main body 201, are used to drive the optical scanning module 204 to move. The drive motor 222 is controlled by the application specific integrated circuit (ASIC) 218. The motor synchronous signal MSYNC is generated from the optical scanning module 204 according to the practical scanning situation, and the action of the drive motor 222 and the scanning procedure can be operated in coordination accurately.

Also, the circuit board 212 receives the power source for scanning via a power line 224, as shown in FIG. 3. The scanning apparatus 200 further includes a first transmission interface 208a, the circuit board 212 outputs the digital image signal DOS′ to a second transmission interface 208b of the controlling device 220 via the first transmission interface 208a. The first transmission interface 208a and the second transmission interface 208b are compatible with a serial transmission interface standard, such as RS-232, USB or IEEE 1394 interface.

### Second Embodiment

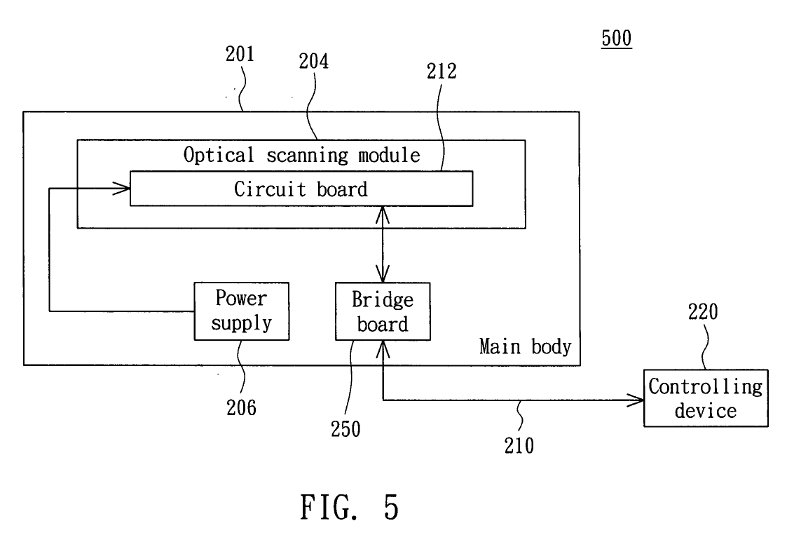

FIG. 5 schematically shows a scanning apparatus in the second embodiment of the present invention. The scanning apparatus 500 includes a main body 201, an optical scanning module 204, a power supply 206 and a bridge board 250. The power supply 206 disposed on the main body 201 is used to provide the power source for driving the optical scanning module 204. The optical scanning module 204 disposed on the main body 201 is used to implement the scanning procedure under the control of the controlling device 220. The bridge board is connected to a interface of the scanning apparatus 200. The optical scanning module 204 is electrically connected to the controlling device 220 via the bridge board 250 and the signal line 210. The bridge board 250, electrically connected to the optical scanning module 204 and the controlling device 220, could be RS-232, USB or IEEE 1394 interface.

### Third Embodiment

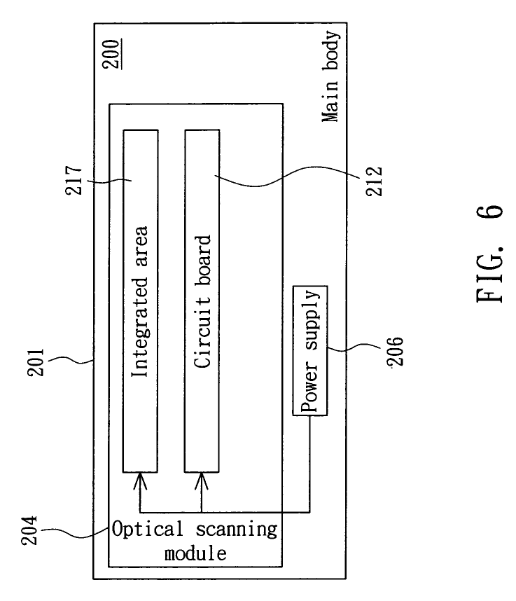

FIG. 6 schematically shows a scanning apparatus in the third embodiment of the present invention. Similar to the first and second embodiments, the scanning apparatus 200 includes an optical scanning module 204, a power supply 206 and a main body 201. However, the difference between the third embodiment and above-mentioned embodiments is the electronic components such as the light-sensing component, the front end processor and the application specific integrated circuit can be disposed in the integrated area 217 and electrically connected to the circuit board 212. The integrated area 217 may be a circuit board or just a flat board for disposing those electronic components. Besides, the circuit board 212 connected to the controlling device can achieve the same result.

According to the aforementioned description, by integrating the light-sensing component, the front end processor, the application specific integrated circuit and the drive motor in the same optical scanning module, the conventional bus lines for communicating the main board with the optical scanning module can be omitted. Therefore, the number of the signal lines is reduced. For example, the digital image signal DOS′ is processed by the circuit board 212, and transmitted to the controlling device 220 directly with less EMI disturbance caused by the bus lines. Hence, the quality of the scanned image can be effectively improved.

While the invention has been describe includes ad by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical scanning module, disposed in a scanning apparatus for acquiring an image of a document, comprising:
a light-sensing component, for sensing a light signal of the document and converting the light signal to an analog image signal;
a front end processor, coupled to the light-sensing component for receiving and converting the analog image signal to a digital image signal; and
an application specific integrated circuit, for receiving and processing the t digital image signal, and outputting an processed digital image signal.

2. The optical scanning module according to claim 1, wherein the light-sensing component, the front end processor and the application specific integrated circuit are disposed on a circuit board.

3. A scanning apparatus, electrically connected to a controlling device wherein the controlling device is used for controlling the scanning apparatus for proceeding scanning procedures, the scanning apparatus comprising:
a main body, and
an optical scanning module, disposed in the main body for acquiring an image of a document, the optical scanning module comprising:
a light-sensing component, for sensing a light signal of the document and converting the light signal to an analog image signal;
a front end processor, coupled to the light-sensing component for receiving and converting the light analog signal to a light digital signal ; and
an application specific integrated circuit, for receiving and processing the digital image signal, and transmitting an processed digital image signal to the controlling device.

4. The scanning apparatus according to claim 3, wherein the light-sensing component, the front end processor and the application specific integrated circuit are disposed on a circuit board.

5. The scanning apparatus according to claim 3, wherein the scanning apparatus is a flatbed scanner and further comprises a drive motor, the drive motor controlled by the application specific integrated circuit is used for driving the optical scanning module to move relatively to the document.

6. The scanning apparatus according to claim 3 further comprising a bridge board disposed in the main body, and the optical scanning module is electrically connected to the controlling device via the bridge board.

7. The scanning apparatus according to claim 6 further comprising a first transmission interface, wherein the digital image signal is transmitted from the optical scanning module to a second transmission interface of the controlling device via the first transmission interface.

8. The scanning apparatus according to claim 7, wherein the first transmission interface and the second transmission interface are compatible with a serial transmission interface standard.

9. The scanning apparatus according to claim 7, wherein the first transmission interface and the second transmission interface are RS-232 serial transmission interface.

10. The scanning apparatus according to claim 7, wherein the first transmission interface and the second transmission interface are USB serial transmission interface.

11. The scanning apparatus according to claim 7, wherein the first transmitting interface and the second transmission interface are IEEE 1394.
